(19) United States
(12) Patent Application Publication
(10) Pub. No.: US 2024/0369733 A1
(43) Pub. Date: Nov. 7, 2024

(54) ESTIMATION OF PHYSICAL PARAMETERS FROM MEASUREMENTS USING SYMBOLIC REGRESSION

(71) Applicant: Halliburton Energy Services, Inc., Houston, TX (US)

(72) Inventors: Huiwen SHENG, Singapore (SG); Sadeed SAYED, Singapore (SG)

(73) Assignee: Halliburton Energy Services, Inc., Houston, TX (US)

(21) Appl. No.: 18/523,311

(22) Filed: Nov. 29, 2023

Related U.S. Application Data
(60) Provisional application No. 63/463,853, filed on May 3, 2023.

(51) Int. Cl. G01V 3/38; E21B 47/18; E21B 49/00; E21B 49/08; G01V 3/34

(52) U.S. Cl. CPC G01V 3/38; E21B 47/18; E21B 49/005; E21B 49/087; G01V 3/34; E21B 2200/22

(57) ABSTRACT

Disclosed is a way of identifying parameters of physical substances from measurement data using symbolic regression. Methods of the present disclosure may receive measurement data and information that identifies parameters of rock samples with known compositions and may generate formulas that estimate relationships between the measurement data and the parameters. Systems of the present disclosure may use transmitters that transmit energy and receivers that sense measurement data in association with the transmitted energy. Formulas generated by these methods may be updated when a model is trained using known parameters. Calculations may be performed, and results of those calculations may be compared to the measurement data. Formulas may be updated until the results calculated according to an updated formula match, to a threshold degree, the measurement data. Once a formula is identified as being “trained,” it may be applied to identify parameters of previously unclassified materials from newly collected measurement data.

### CROSS-REFERENCE TO RELATED APPLICATIONS

This application claims benefit of U.S. Provisional Application No. 63/463,853 filed May 3, 2023, which is incorporated herein by reference.

### BACKGROUND

### Technical Field

The present disclosure generally relates to solutions for estimating physical parameters and in particular, for estimating physical parameters based on sensor measurement data using a symbolic regression machine-learning model.

### Introduction

Indirect estimation of physical parameters using acoustic and electromagnetic measurements is a crucial aspect of the oil and gas industry. In order to maximize production and improve operational efficiency, it is essential to have accurate information about the properties of the rock and fluids within the wellbore. However, direct measurement of these properties can be difficult or impossible in some cases, and therefore indirect estimation is often required.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1A illustrates a diagram of an example logging while drilling wellbore operating environment, in accordance with various aspects of the subject technology.

FIG. 1B illustrates a diagram of an example downhole environment having tubulars, in accordance with various aspects of the subject technology.

FIG. 2 illustrates a conceptual system diagram for training a symbolic regression model, according to some aspects of the disclosed technology.

FIG. 3 illustrates an example of a trained symbolic regression model that is configured to generate physical parameter estimates based on wellbore sensor measurements, according to some aspects of the disclosed technology.

FIG. 4 illustrates actions that may be performed when a symbolic regression model is trained, according to some aspects of the disclosed technology.

FIG. 5 illustrates an example of a deep learning neural network that can be used to implement a symbolic regression model, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

Disclosed is a way of identifying parameters of physical substances from measurement data using symbolic regression. Methods of the present disclosure may receive measurement data and information that identifies parameters of rock samples with known compositions and may generate formulas that estimate relationships between the measurement data and the parameters. Systems of the present disclosure may use transmitters that transmit energy and receivers that sense measurement data in association with the transmitted energy. Formulas generated by these methods may be updated when a model is trained using known parameters. Calculations may be performed, and results of those calculations may be compared to the measurement data. Formulas may be updated until the results calculated according to an updated formula match, to a threshold degree, the measurement data. Once a formula is identified as being “trained,” it may be applied to identify parameters of previously unclassified materials from newly collected measurement data.

In many instances, obtaining direct measurements of various physical parameters in oil wells, such as soil or pipe corrosion properties, are not practically possible. To overcome this challenge, methods of the present disclosure may utilize indirect measurement techniques based on acoustic and/or electromagnetic (EM) transmitters and receivers to estimate an unknown parameter. For example, attenuation of acoustic or EM energy may be known for different densities of known materials and known mixtures of fluids when new sensor data does not correspond to these known material densities and fluid mixtures (to a threshold level). In such an instance, formulas used to correlate attenuation to material density and fluid content may be used to identify parameters that correspond to the new sensor data by updating parameters associated with the formulas or by identifying new parameters to include in a revised formula. As such an estimate of one or more unknown parameters may be made by updating formulas that model attenuation density and fluid content, for example. Parameters of these formulas may be added or otherwise updated (e.g., changed in value) until calculated results match measured data to a threshold level.

One of the main advantages of indirect estimation is that it can provide a more comprehensive picture of the physical properties of the formation and fluids within the wellbore. Unlike direct measurements, which are typically limited to a small number of locations within the wellbore, indirect measurements can be taken over a wide range of depths and locations. This allows for a more complete understanding of the reservoir and can improve production efficiency.

Estimation of the physical parameters from these measurements can be a challenging task. This is due to the complex relationships between the unknown parameters and the measurements. To obtain useful results, the user generally relies on either solving an optimization problem with carefully selected regularization parameters along with manual adjustments or uses a well-trained neural network. However, there are also several drawbacks associated with the use of neural networks or optimization problems in estimating parameters from measurements, which in certain instances can include:

Overfitting: Neural networks can be prone to overfitting, which occurs when the model becomes overly complex and starts to fit the noise in the data instead of limiting fitting to underlying patterns. This can lead to poor generalization performance, where the model performs well on the training data but poorly on new data.

Choice of hyperparameters: Neural networks have many hyperparameters that need to be tuned, such as the number of layers, the number of neurons per layer, the learning rate, and the regularization strength. Choosing appropriate hyperparameters can be challenging and time-consuming.

Local optima: Optimization problems can be prone to getting stuck in local optima, where the algorithm finds a solution that is not a global optimum yet is only a solution in a the local region. This can lead to suboptimal solutions and poor performance of a modeling system.

Lack of interpretability: Neural networks can be difficult to interpret, especially when their complexity reaches a threshold level.

Data requirements: Neural networks require a large amount of data to train effectively. In instances when training data is noisy or incomplete, neural network implementations can have poor performance and such implementations may generate inaccurate parameter estimates.

Aspects of the disclosed technology address the foregoing limitations of conventional neural-network approaches to physical parameter estimation by providing a novel machine-learning approach in which physical parameter estimation can be performed using symbolic regression. Symbolic regression is a machine learning technique that aims to find one or more explicit mathematical expressions that fit a given set of data. Such an expression may also be referred to as a formula, equation, or function expressed using mathematical operators. Such expressions may also include variables or constants or combinations thereof that may be coefficients of a formula.

Operators such as a plus sign, a minus sign, a times symbol, a division symbol, a trigonometric function (e.g., Tangent, Sine, Cosine, or other periodic function), or other symbol may be used to express mathematical operations of a mathematical formula. A given mathematical formula may be expressed in terms of mathematical operations such as addition, subtraction, multiplication, division, exponentiation, and/or another operator. Symbolic regression is unlike traditional regression methods that fit a predefined functional form, as symbolic regression generates a mathematical formula that can be expressed in terms of mathematical operations that are not necessarily predefined.

Symbolic regression can be used to derive mathematical equations that describe a set of observed data or stored set of data. In an instance when a set of data includes values of a first dimension (e.g., the Y dimension) and values of a second dimension (e.g., the X dimension), mathematical building blocks may be combined using mathematical operators, constants, and/or variables. For example, a formula of the form Y=AX²+BX+C may be selected and evaluation may be performed. In such an instance, values of X of a stored set of data may be accessed and terms A, B, and C may be constants used to calculate values of Y from the accessed X values. When values of Y calculated from values of X and values of constants A, B, and C match values of Y in the stored dataset to a threshold degree or level, the formula describing the dataset data may be identified. Applications of the present disclosure may use symbolic regression to identify relationships associated with wellbore measurement data and physical parameters of subterranean formations that surround a wellbore.

While, in certain instances symbolic regression may be implemented using neural networks, a neural network implementation may not be as efficient or effective as using generic algorithms to generate a result from collected data. Compared to optimization problems that may be associated with neural network implementations, algorithmic symbolic regression offers several advantages. One of the advantages of symbolic regression, especially algorithmic symbolic regression, is that it can help to identify previously unknown relationships between variables. For example, it can reveal nonlinear relationships that might be missed by more traditional regression techniques. This can be particularly useful in the study of physical systems, where complex and nonlinear relationships are common.

Symbolic regression can also help researchers identify variables that are most relevant to a description of a physical system. Symbolic regression may be used to quantify relative importance of each variable of a set of variables used in an expression/formula. This can be useful for designing experiments or simulations that focus on variables that are classified as being “most important variables.” By identifying variables that have a greater sensitivity or greater relevance to a particular circumstance may allow for models to be developed that capture essential features of a system.

One technique that may be used to identify variables that should be considered as “important variables” is a correlation evaluation. Examples of techniques that may be used to perform such correlation evaluations include Pearson and Spearman correlation techniques. Such a correlation evaluation may identify whether a first parameter (e.g., density) is more relevant than a second parameter (e.g., porosity) to correctly model the transmission of electromagnetic (EM) signals through subterranean rocks, for example. In certain instances, these “important variables” may be identified before a symbolic regression training session is performed.

In certain instances, an expression of an expected result (or target dataset) and different parameters may be included in a symbolic regression. Based on the expression, specific contributions of different parameters to the target dataset can be analyzed. Furthermore, a sensitivity study can be done. Such a sensitivity study may identify whether changes in a parameter of an equation affect results of an expression/formula more or less than a threshold level.

Algorithmic symbolic regression offers several advantages over conventional neural network techniques or techniques that use neural networks to perform symbolic regression and optimization problems. These benefits include identifying solutions that can be interpreted by engineers or scientists (e.g., Petro-physicists and geologists). Algorithmic symbolic regression may generate solutions more quickly and accurately as compared to other techniques, may identify relevant solutions when relatively small amounts of measured data are available, and may scale better than conventional techniques. Symbolic regression will also tend to be less prone to overfitting than neural network techniques and will tend to obtain more generalized results as compared to other techniques where relationships between variables is not clearly visible.

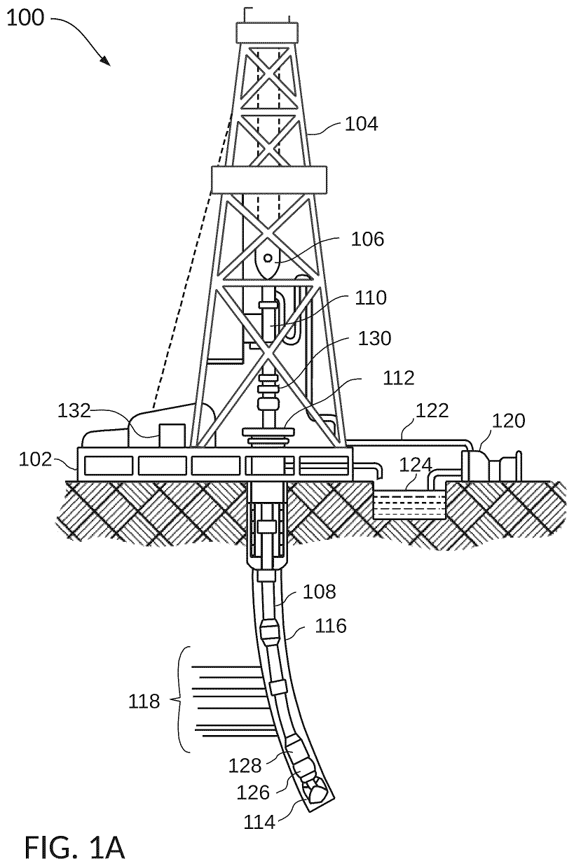

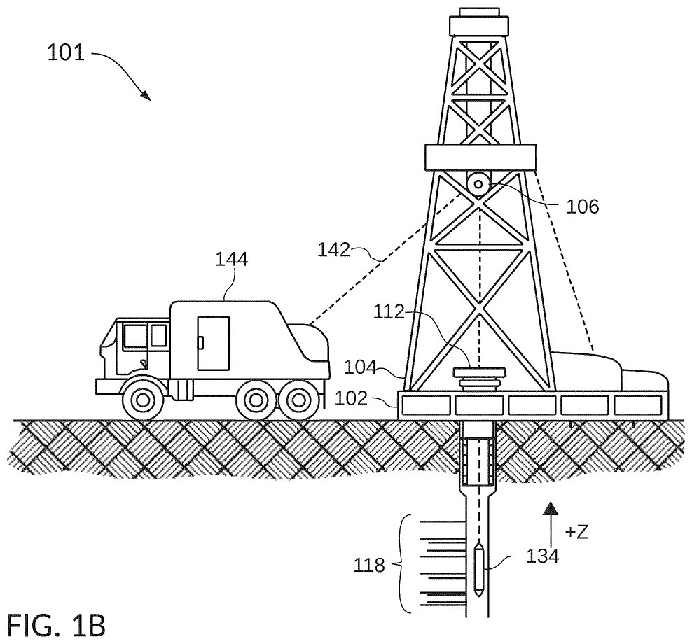

FIG. 1A illustrates a diagram of an example logging while drilling wellbore operating environment 100. As illustrated, drilling platform 102 supports derrick 104 having traveling block 106 for raising and lowering drill string 108. Kelly 110 supports drill string 108 as it is lowered through rotary table 112. Drill bit 114 is driven by a downhole motor and/or rotation of drill string 108. As bit 114 rotates, it creates a borehole 116 that passes through various formations 118. Pump 120 circulates drilling fluid through a feed pipe 122 to kelly 110, downhole through the interior of drill string 108, through orifices in drill bit 114, back to the surface via the annulus around drill string 108, and into retention pit 124. The drilling fluid transports cuttings from the borehole into pit 124 and aids in maintaining borehole integrity.

Downhole tool 126 can take the form of a drill collar (i.e., a thick-walled tubular that provides weight and rigidity to aid the drilling process) or other arrangements known in the art. Further, downhole tool 126 can include various sensor and/or telemetry devices, including but not limited to: acoustic (e.g., sonic, ultrasonic, etc.) logging tools and/or one or more magnetic directional sensors (e.g., magnetometers, etc.). In this fashion, as bit 114 extends the borehole through formations 118, the bottom-hole assembly (e.g., directional systems, and acoustic logging tools) can collect various types of logging data. For example, acoustic logging tools can include transmitters (e.g., monopole, dipole, quadrupole, etc.) to generate and transmit acoustic signals/waves into the borehole environment. These acoustic signals subsequently propagate in and along the borehole and surrounding formation and create acoustic signal responses or waveforms, which are received/recorded by evenly spaced receivers. These receivers may be arranged in an array and may be evenly spaced apart to facilitate capturing and processing acoustic response signals at specific intervals. The acoustic response signals are further analyzed to determine borehole and adjacent formation properties and/or characteristics.

For purposes of communication, a downhole telemetry sub 128 can be included in the bottom-hole assembly to transfer measurement data to surface receiver 130 and to receive commands from the surface. In some implementations, mud pulse telemetry may be used for transferring tool measurements to surface receivers and receiving commands from the surface; however, other telemetry techniques can also be used, without departing from the scope of the disclosed technology. In some embodiments, telemetry sub 128 can store logging data for later retrieval at the surface when the logging assembly is recovered. These logging and telemetry assemblies consume power, which must often be routed through the directional sensor section of the drill string, thereby producing stray EM fields which interfere with the magnetic sensors.

At the surface, surface receiver 130 can receive the uplink signal from downhole telemetry sub 128 and can communicate the signal to data acquisition module 132. Module 132 can include one or more processors, storage mediums, input devices, output devices, software, and the like as described in further detail below. Module 132 can collect, store, and/or process the data received from tool 126 as described herein.

FIG. 1B illustrates a diagram of an example downhole environment 101 having tubulars. At various times during the drilling process, drill string 108 may be removed from the borehole as shown in example environment 101, illustrated in FIG. 1B. Once drill string 108 has been removed, logging operations can be conducted using a downhole tool 134 (i.e., a sensing instrument sonde) suspended by a conveyance 142. In one or more embodiments, the conveyance 142 can be a cable having conductors for transporting power to the tool and telemetry from the tool to the surface. Downhole tool 134 may have pads and/or centralizing springs to maintain the tool near the central axis of the borehole or to bias the tool towards the borehole wall as the tool is moved downhole or uphole.

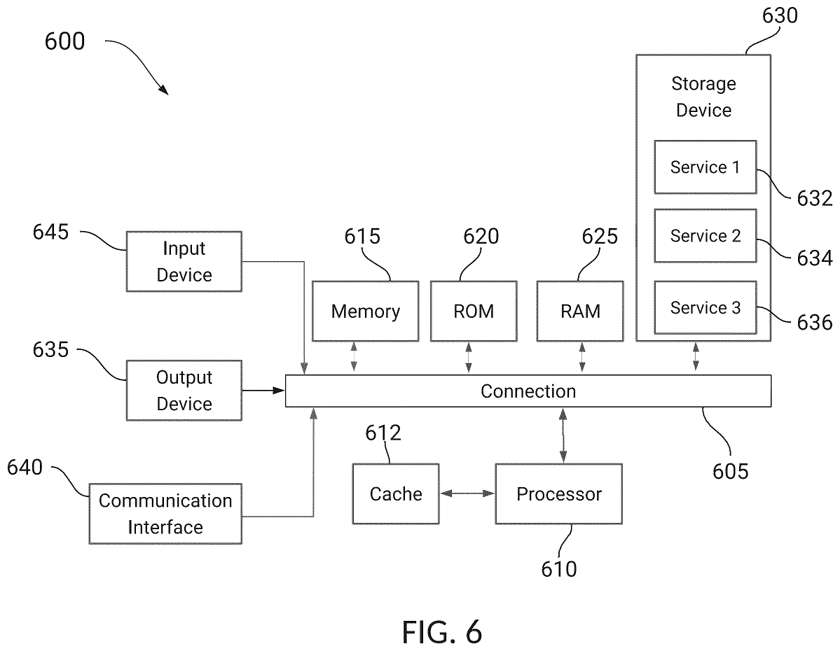

Downhole tool 134 can include various directional and/or acoustic logging instruments that collect data within borehole 116. A logging facility 144 includes a computer system, such as those described with reference to FIG. 6, discussed below, for collecting, storing, and/or processing the measurements gathered by logging tool 134. In one or more embodiments, the conveyance 142 of downhole tool 134 can be at least one of wires, conductive or non-conductive cable (e.g., slickline, etc.), as well as tubular conveyances, such as coiled tubing, pipe string, or downhole tractor. Downhole tool 134 can have a local power supply, such as batteries, downhole generator and the like. When employing non-conductive cable, coiled tubing, pipe string, or downhole tractor, communication can be supported using, for example, wireless protocols (e.g. EM, acoustic, etc.), and/or measurements and logging data may be stored in local memory for subsequent retrieval.

Although FIGS. 1A and 1B depict specific borehole configurations, it is understood that the present disclosure is equally well suited for use in wellbores having other orientations including vertical wellbores, horizontal wellbores, slanted wellbores, multilateral wellbores and the like. While FIGS. 1A and 1B depict an onshore operation, it should also be understood that the present disclosure is equally well suited for use in offshore operations. Moreover, the present disclosure is not limited to the environments depicted in FIGS. 1A and 1B and can also be used in either logging-while-drilling (LWD) or measurement while drilling (MWD) operations.

It is also understood that the wellbores discussed and production from such wellbores which may be an ultimate outcome of the present disclosure, may, in addition to wells for production of hydrocarbons, also include wells for production of geothermal energy, and wells for injection or sequestration or storage of materials (e.g. steam, waste material, CO2, or hydrogen), for which the well construction and completion processes are similar to those for hydrocarbons, and the implementations herein also apply.

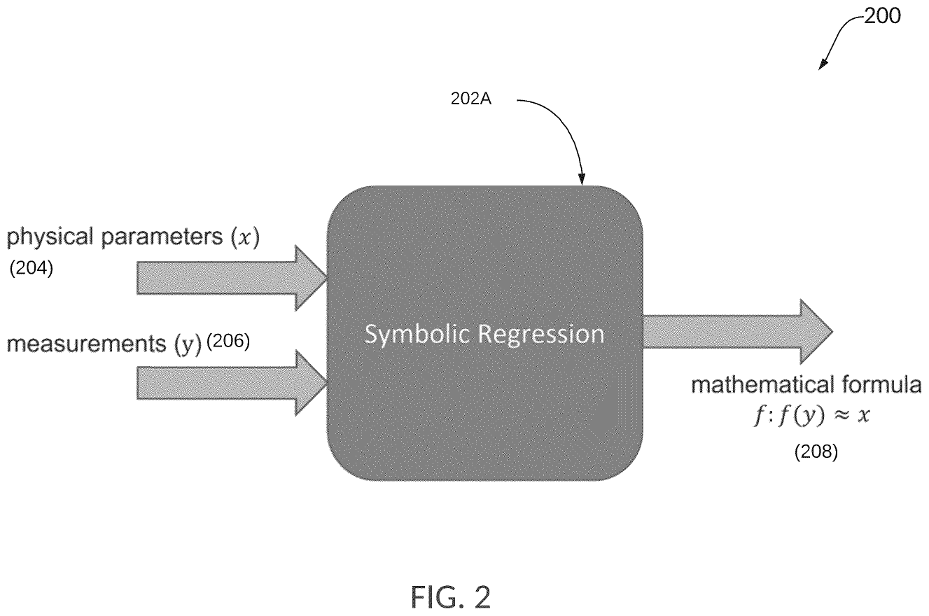

FIG. 2 illustrates a conceptual system 200 for training a symbolic regression model 202A. To perform training, known physical parameters (x) 204 for a set of sensor measurements (y) 206 can be provided as an input to symbolic regression model 202A. Known physical parameters may be associated with a wellbore casing or with properties of formations located around or near a wellbore. Examples of known physical parameters (x) 204 include or may be related to values of porosity, permeability, permittivity, conductivity, resistivity, density, pore size, attenuation, or types of materials or fluids.

Sensor measurements (y) 206 may have been collected using any form of equipment and data collected by these measurements may have characteristics associated with a type of measurement device. For example, measurement data may be electronic measurement data collected based on electromagnetic (EM) fields that propagate through subterranean strata or cuttings from subterranean strata. In such instances, one or more coils or antennas of an EM sensing device or system may emit EM fields into the Earth either at the Earth's surface or from emitters located in a wellbore. Alternatively, or additionally, measurement data may be collected in a laboratory environment. Measurement data collected by an EM device or system may include magnitudes of voltage or current, phases of voltages or current, or combinations thereof.

Alternatively, or additionally, acoustic data may be collected by acoustic, nuclear magnetic resonance (NMR), or other logging devices or systems. Acoustic devices or systems may emit acoustic (e.g., ultrasonic, sonic, or subsonic) waves into subterranean strata and acoustic sensing devices, may collect acoustic data after emitted acoustic waves have propagated through or reflected off of objects located within strata of a wellbore. Examples of acoustic measurements include a magnitude of an acoustic wave, a phase change of an acoustic wave, a compressional velocity associated with an acoustic wave, a sheer velocity of an acoustic wave, and propagation delay of an acoustic wave. Sensor measurements may include measures of voltage, current, or phases of voltage or current signals sensed by a sensor that senses acoustic waves.

A resulting (output) of mathematical formula 208 provides an estimated mathematical relationship between measurements (y) 206 and the known physical parameters (x) 204. For use in wellbore applications, physical parameters (x) 204 may relate to formation or wellbore properties, such as permittivity and/or conductivity properties. Measurements (y) 206 may relate to permittivity and/or conductivity measurements for example, that are logged using an acoustic or electromagnetic (EM) measurement tool (e.g., acoustic, EM, or NMR sensors/sensing tool). It is understood that other (or different) measurements (y) 206 and/or physical parameters (x) 204 may be measured without departing from the scope of the disclosed technology. One or more known parameters included in a formula may have a value associated with them. For example, a measure of resistivity may include units of resistance per centimeter and this value may be updated when a formula is updated or otherwise revised.

Once the mathematical formula 208 is generated by the symbolic regression model 202A, a parameter selection process can be performed, for example, to adjust the output expression to the parameters of the training data (204, 206). Parameters may be selected before a symbolic regression process is initiated. Subsequently, a process of symbol selection can be performed, for example, to determine or specify what mathematical symbols (or expressions) should be used to express a mathematical formula 208 or to link terms included in a mathematical formula 208. In certain instances, symbol selection may be influenced by training data and validation data used to train the model. Once one or more output expressions have been generated using symbolic regression model 202A, the formulas can be collected and selected for use on new (non-training) data, for example, for use in facilitating the identification of physical parameters in new scenarios. The process of symbolic regression 202A may include modifying values of constants used in one or more formulas or may modify symbols used in a mathematical formula. As such a formula may be updated when values generated from calculations using the formula do not match, to a threshold level, values associated with measured data. For example, this may include modifying values of constants a, b, and/or c in equation x=[a (Sin y)−b (Cos y)+c] d, or by changing a symbol used in this equation (e.g., changing a plus symbol to a minus symbol).

Depending on the desired implementation, the training process of FIG. 2 may be performed using data collected at different areas of the wellbore (e.g., at different depths), for different sections of the wellbore pipe, or based on variance in measurement conditions. Examples of conditions that vary in a wellbore may include temperature and pressure conditions. Properties included in strata that surround the wellbore may vary based on these temperature and pressure conditions. Furthermore, properties of subterranean formations or materials may also change. This means that formulas used to represent correspondences between sensed data and physical parameters may change with wellbore conditions. As such, variations in parameters and measurements provided to a symbolic regression process may result in different mathematical formulas being generated as outputs that are each associated with specific locations a wellbore.

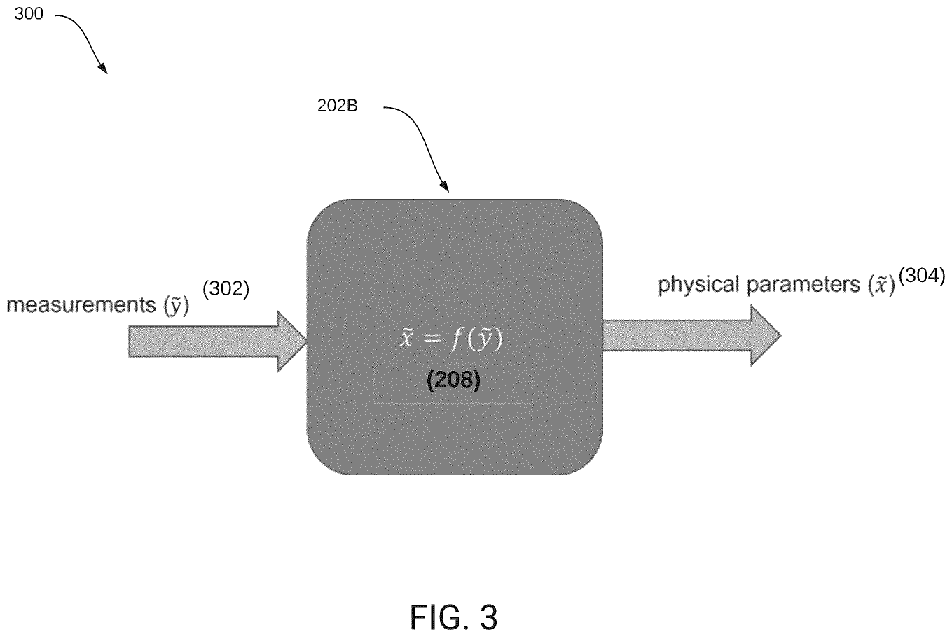

FIG. 3 illustrates an example of a trained symbolic regression model 202B that is configured to generate physical parameter estimates 304 based on wellbore sensor measurements 302. After the symbol regression model 202A of FIG. 2 is trained, measurements (y) 302 may be collected when a wellbore logging tool is deployed in a wellbore. Measurements (y) 302 may be collected by the same type or combination of logging equipment as measurements (y) 206 discussed in respect to FIG. 2. As such, measurements (y) 302 may be sensor measurements collected using an EM, acoustic, NMR, or other type of logging tool that is deployed in a wellbore.

New wellbores may be drilled at locations that have not yet been characterized. As such, when wellbore sensing devices are deployed in a new wellbore, parameters associated with rocks and fluids located around a wellbore are unknown. Since trained symbolic regression model 202B maps measured data to physical parameters based on a trained formulaic model, trained symbolic regression model 202B may be used to identify physical parameters of a wellbore from measurement data. As such, measurements (y) 302 may be collected when magnetic, EM, or acoustic waves travel through or otherwise encounter materials located in a formation around the wellbore. These measurements may correspond to specific types of wellbore material properties that each may have their own set of relevant physical parameters.

Since trained symbolic regression model 202B may be used to identify material properties identified from measurements (y) 302 using mathematical expression 208 learned from the training process, newly collected measurements 302 may be used to identify physical parameters (x) 304 of a new wellbore. This means that by training a symbolic regression model with sensed data and with physical parameters associated with known material types (e.g., granite, sand, oil, water, and/or other type of known material) with known parameters (e.g., porosity, permeability, permittivity, conductivity, resistivity, density, pore size, attenuation, or other parameter) that measurements collected from a new wellbore may be used to identify parameters of a new wellbore using trained model 202B. One or more known parameters included in a formula may have a value associated with them. For example, a measure of resistivity may include units of resistance per centimeter.

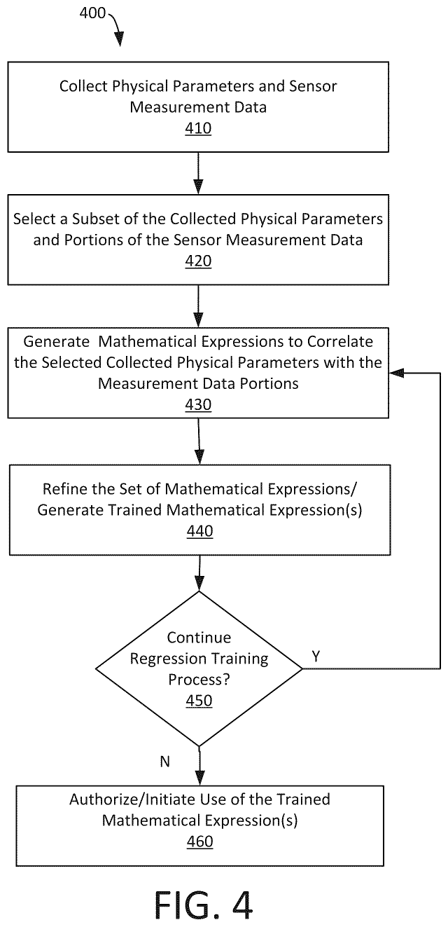

FIG. 4 illustrates actions that may be performed when a symbolic regression model is trained. Actions performed by process 400 of FIG. 4 may be used to train a symbolic regression computer model such that estimates of physical parameters of a wellbore can be identified from wellbore sensor measurement data using the trained symbolic regression computer model.

At block 410, the process 400 may include collecting (or receiving) physical parameters and sensor measurements of a previously characterized wellbore or set of rock samples. When data associated with a previously characterized wellbore are used, sensed wellbore data (e.g., previous wellbore logging data) and previous determinations of physical parameters may be used to train the computer model. In other instances, known physical parameters and sensor measurement data may be identified or collected in a controlled setting such as in a laboratory. Once a set of physical parameters and sensor data have been identified or collected, particular physical parameters and portions of sensor data may be selected based an analysis that correlates physical parameter and measurement data inputs to mathematical functions that describe how the physical parameters correlate to measured data.

At block 420, a subset of the physical parameters and portions of the measurement data collected at block 410 may be selected. The selected physical parameters and portions of measurement data may be selected based on physical parameters that are known to affect measurement data in ways that are more likely to be interrelated. For example, when a set of measurement data is known to include sandstone with a given porosity and when sandstone of that porosity is known to attenuate acoustic signals of certain frequencies more rapidly than other frequencies, physical parameters associated with the attenuation of acoustic energy through that sandstone porosity may be selected when acoustic measurement data associated with specific frequencies is selected from a set of measurement data at block 420.

At block 420 a set of mathematical expressions/formula may be generated. These expressions may correlate the selected physical parameters with the selected portions of measurement data. In an instance when sandstone of a porosity X is known to attenuate acoustic 10 thousand Hertz (KHz) signals at a rate of 15 decibels (dB) per centimeter (cm) and is known to attenuate acoustic 20 KHz signals at a rate of 25 dB per cm, a formula that simulates attenuation as a function of porosity X and frequency F may be generated at block 420. Received acoustic data may be filtered, and magnitudes of that acoustic data at different frequencies (e.g., 10 KHz and 20 KHz) may be selected and then used to calculate attenuation in dB per cm at each of the selected frequencies. Values of attenuation may be calculated according to the attenuation formula and these calculated values may be compared to the measured values. In instances when the calculated values differ from the measured values by more than a threshold amount, the formula may be modified, updated calculations may be performed, and results of the updated calculations may be compared with the measured values again. When calculated values match the measured within the threshold amount, the formula that associates acoustic attenuation in sandstone of given porosities may be selected for use by a trained symbolic regression model. In this way, actions performed at block 440 may refine a mathematical expression/formula to generate a trained expression.

This algorithmic symbolic regression technique may generate accurate formulaic relationships even when only limited amounts of data are used to train the model. For example, a formula that associates frequency to attenuation using data that spans 15 KHz to 20 KHz may be used to model attenuation at frequencies below 15 KHz and above 20 KHz.

Determination block 450 may identify whether the regression training process of FIG. 4 should be continued. Criteria for determining whether a training process is complete may be established by a user or may be a function of instructions of the computer model. This criterion may dictate that specific physical parameters must be associated with specific types of measurement data until equations are generated that correlate the physical parameters to measured data according to predefined thresholds. Examples of such thresholds include requiring that calculated values should match values derived from measurement data (measurement values) by a percentage of the measurement values or the calculated values. Measurement data may include data that is directly measured (e.g., amplitude or phase shift) and may include data derived from directly measured data (e.g., changes in amplitude or phase shift over distance). Attenuation over distance, for example, may be calculated by subtracting a first measurement of amplitude from a second measure of amplitude when each of these amplitudes were measured using sensors located at different distances from an energy source.

When determination block 450 identifies that the training process should be continued, program flow may move back to block 430 where additional mathematical expressions may be generated. When determination block 450 identifies that the training process should not be continued, program flow may move to block 460 where the trained mathematical expressions may be authorized for use. As such formulas generated by training process 400 may be provided to scientists or engineers or operation of the symbolic regression model be configured to use these formulas. Block 430 may also select mathematical symbols or operators that may be included in an expression or that may link different expressions together. For example, an acoustic attenuation formula may be linked to a formula that accounts for the dissipation or additive reflection of acoustic energy caused by a change in material density with an appropriate mathematical symbol (e.g., a plus sign).

The one or more mathematical expressions/formulas generated at block 430 may relate the physical parameters to the sensor measurement data. As discussed above, mathematical expressions/formulas may be generated using a symbolic regression model that is configured to produce mathematical relationships that relate physical parameters to sensor measurement data. Examples of such physical parameters may include yet are not limited to parameters of porosity, permittivity, conductivity, resistivity, density, pore size, material type, or fluid type that may exist in a wellbore. Outputs of this training process may include one or more trained expressions/formulas that associate physical parameters with measured data. These formulas may be provided to scientists such that the scientists can learn from the training process. These trained formulas may be incorporated into the computer model such that a processor may execute instructions out of a memory when that processor identifies properties associated with an uncharacterized wellbore from sensed data using the trained formulas.

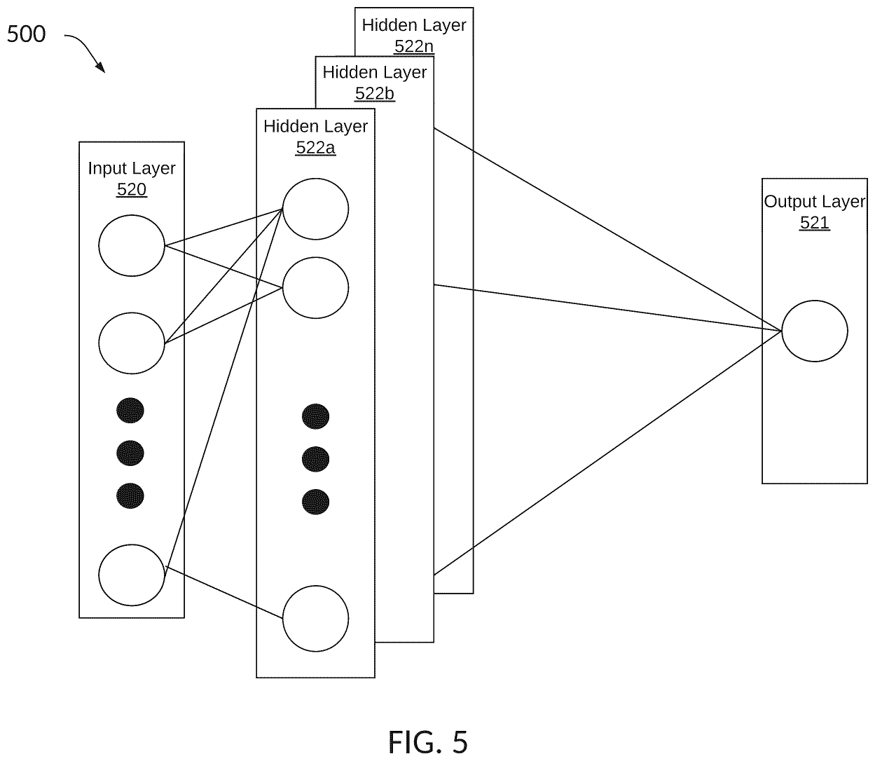

FIG. 5 is an example of a deep learning neural network that can be used to implement a symbolic regression model consistent with the present disclosure. All or a portion of the systems and techniques described herein (e.g., neural network 500 can be used to implement a symbolic regression model, as discussed above). Neural network 500 includes multiple hidden layers 522a, 522b, through 522n. A hidden layer of a neural network may be referred to as a process (a layer) that lies between input and output processes (layers) of the neural network.

The hidden layers 522a, 522b, through 522n include “n” number of hidden layers, where “n” is an integer greater than or equal to one. The number of hidden layers can be made to include as many layers as needed for a given application. Neural network 500 further includes an output layer 521 that provides an output resulting from the processing performed by the hidden layers 522a, 522b, through 522n.

The neural network 500 may be a multi-layer neural network of interconnected nodes. Each node can represent a piece of information. Information associated with the nodes may be shared among the different layers and each layer may retain information as information is processed. In some cases, the neural network 500 can include a feed-forward network, in which case there may be few or no feedback connections and where outputs of the network may only be fed back according to certain constraints. In some instances, the neural network 500 can include a recurrent neural network, which can have loops that allow information to be carried across nodes while reading in input.

Inputs may be provided to the neural network and these inputs may be provided to layers that have a function, where inputs are mapped to specific functions or equations. Other hidden layers may perform mathematical functions (e.g., addition). After a series of functions have been performed, an output may be provided to an output layer of the neural network.

Information may be exchanged between nodes of the neural network through node-to-node interconnections between the various layers. These node-to-node configurations may be configured to perform computations used as part of a symbolic regression process. Nodes of the input layer 520 can activate a set of nodes in the first hidden layer 522a. For example, as shown, each of the input nodes of the input layer 520 is connected by lines in FIG. 5 to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output) 2). The loss can be set to be equal to the value of E_total.

The loss (or error) may be be high for the initial training data since the actual values may be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example apparatus (e.g., a processor-based system) with which some aspects of the subject technology can be implemented. For example, processor-based system 600 can be any computing device known in the art.

Computing system 600 can be (or may include) a distributed system in which the functions described in this disclosure can be distributed within a datacenter, multiple data centers, a peer network, etc. In some embodiments, one or more of the described system components represents many such components each performing some or all the functions for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Statements of the Disclosure:

Statement 1: A method for improving a computer model, the method comprising identifying a formula to associate collected data with a set of known parameters of a sample; calculating a first set of values according to the formula based on the known parameters of the sample; identifying that the first set of values do not correspond to the collected logging data; identifying an updated formula to calculate a second set of values; and identifying that the second set of values correspond to the collected data, wherein the updated formula is classified as a trained formula based on the identification that the second set of values correspond to the collected data, and wherein the trained formula is associated with the computer model.

Statement 2: The method of Statement 1, the method of claim 1, further comprising accessing the collected data associated with the sample; and accessing the set of known parameters of the sample.

Statement 3: The method of Statement 1 or Statement 2, The method of claim 1, further comprising comparing the collected data with first set of calculated values; and generating the updated formula based on the identification that the first set of calculated values do not correspond to the collected data.

Statement 4: The method of any of Statements 1 through 3, wherein the sample is located in at least one of a wellbore or a cutting taken from the wellbore.

Statement 5: The method of any of Statements 1 through 4, further comprising accessing data sensed in a wellbore; performing evaluations according to the updated formula based on the sensed wellbore data; and identifying parameters of a subterranean formation of the wellbore based on the evaluations being performed according to the updated formula.

Statement 6: The method of any of Statements 1 through 5, wherein the collected data includes data from one or more electromagnetic (EM) measurements, magnetic flux leakage measurements, nuclear magnetic resonance measurements, or acoustic measurements.

Statement 7: The method of any of Statements 1 through 6, wherein the collected data includes data associated with propagation of EM energy or acoustic energy through the sample.

Statement 8: The method of any of Statements 1 through 7, further comprising accessing sensor data; identifying that a calculation according to the formula that includes the set of known parameters does not generate results that match the sensor data to a threshold level; generating a revised formula based on an estimate of a new parameter or a parameter of the set of known parameters; identifying that a calculation according to the revised formula generates results that match the sensor data to the threshold level; and estimating an unknown parameter based on information associated with known physical parameters.

Statement 9: A non-transitory computer-related storage medium having embodied thereon instructions that when executed by one or more processors perform a method comprising identifying a formula to associate collected data with a set of known parameters of a sample; calculating a first set of values according to the formula based on the known parameters of the sample; identifying that the first set of values do not correspond to the collected data; identifying an updated formula to calculate a second set of values; and identifying that the second set of values correspond to the collected data, wherein the updated formula is classified as a trained formula based on the identification that the second set of values correspond to the collected data, and wherein the trained formula is associated with a computer model.

Statement 10: The non-transitory computer-related storage medium of Statement 9, wherein the one or more processors execute the instructions to access the collected data associated with the sample; and access the set of known parameters of the sample.

Statement 11: The non-transitory computer-related storage medium of Statement 9 or Statement 10, wherein the one or more processors execute the instructions to compare the collected data with first set of calculated values; and generate the updated formula based on the identification that the first set of calculated values do not correspond to the collected data.

Statement 12: The non-transitory computer-related storage medium of any of Statement 9 through 11, wherein the sample is located in at least one of a wellbore or a cutting taken from the wellbore.

Statement 13: The non-transitory computer-related storage medium of any of Statement 9 through 12, wherein the one or more processors execute the instructions to access data sensed in a wellbore; perform evaluations according to the updated formula based on the sensed wellbore data; and identify parameters of a subterranean formation of the wellbore based on the evaluations being performed according to the updated formula.

Statement 14: The non-transitory computer-related storage medium of any of Statement 9 through 13, wherein the collected data includes data from one or more electromagnetic (EM) measurements, magnetic flux leakage measurements, nuclear magnetic resonance measurements, or acoustic measurements.

Statement 15: The non-transitory computer-related storage medium of any of Statement 9 through 14, wherein the collected data includes data associated with propagation of EM energy or acoustic energy through the sample.

Statement 16: The non-transitory computer-related storage medium of any of Statement 9 through 15, wherein the one or more processors execute the instructions to access sensor data; identify that a calculation according to the formula that includes the set of known parameters does not generate results that match the sensor data to a threshold level; generate a revised formula based on an estimate of a new parameter or a parameter of the set of known parameters; and identify that a calculation according to the revised formula generates results that match the sensor data to the threshold level.

Statement 17: An apparatus comprising a memory; and one or more processors that execute instructions out of the memory to: identify a formula to associate collected data with a set of known parameters of a sample, calculate a first set of values according to the formula based on the known parameters of the sample, identify that the first set of values do not correspond to the collected data, identify an updated formula to calculate a second set of values, and identify that the second set of values correspond to the collected data, wherein the updated formula is classified as a trained formula based on the identification that the second set of values correspond to the collected data, and wherein the trained formula is associated with a computer model.

Statement 18: The apparatus of Statement 17, wherein the one or more processors that execute instructions out of the memory to: compare the collected data with first set of calculated values, and generate the updated formula based on the identification that the first set of calculated values do not correspond to the collected data.

Statement 19: The apparatus of Statement 17 or Statement 18, wherein the one or more processors execute instructions out of the memory to: access data sensed in a wellbore, perform evaluations according to the updated formula based on the sensed wellbore data, and identify parameters of a subterranean formation of the wellbore based on the evaluations being performed according to the updated formula.

Statement 20: The apparatus of any of Statement 17 through 19, further comprising a measurement device that collects one or more of an electromagnetic measurement, a magnetic flux leakage measurement, a nuclear magnetic resonance measurement, or an acoustic measurement.

What is claimed is:

1. A method for improving a computer model, the method comprising:
identifying a formula to associate collected data with a set of known parameters of a sample;
calculating a first set of values according to the formula based on the known parameters of the sample;
identifying that the first set of values do not correspond to the collected logging data;
identifying an updated formula to calculate a second set of values; and
identifying that the second set of values correspond to the collected data, wherein the updated formula is classified as a trained formula based on the identification that the second set of values correspond to the collected data, and wherein the trained formula is associated with the computer model.

2. The method of claim 1, further comprising:
accessing the collected data associated with the sample; and
accessing the set of known parameters of the sample.

3. The method of claim 1, further comprising:
comparing the collected data with first set of calculated values; and
generating the updated formula based on the identification that the first set of calculated values do not correspond to the collected data.

4. The method of claim 1, wherein the sample is located in at least one of a wellbore or a cutting taken from the wellbore.

5. The method of claim 1, further comprising:
accessing data sensed in a wellbore;
performing evaluations according to the updated formula based on the sensed wellbore data; and
identifying parameters of a subterranean formation of the wellbore based on the evaluations being performed according to the updated formula.

6. The method of claim 1, wherein the collected data includes data from one or more electromagnetic (EM) measurements, magnetic flux leakage measurements, nuclear magnetic resonance measurements, or acoustic measurements.

7. The method of claim 1, wherein the collected data includes data associated with propagation of EM energy or acoustic energy through the sample.

8. The method of claim 1, further comprising:
accessing sensor data;
identifying that a calculation according to the formula that includes the set of known parameters does not generate results that match the sensor data to a threshold level;
generating a revised formula based on an estimate of a new parameter or a parameter of the set of known parameters;
identifying that a calculation according to the revised formula generates results that match the sensor data to the threshold level; and
estimating an unknown parameter based on information associated with known physical parameters.

9. A non-transitory computer-related storage medium having embodied thereon instructions that when executed by one or more processors perform a method comprising:
identifying a formula to associate collected data with a set of known parameters of a sample;
calculating a first set of values according to the formula based on the known parameters of the sample;
identifying that the first set of values do not correspond to the collected data;
identifying an updated formula to calculate a second set of values; and
identifying that the second set of values correspond to the collected data, wherein the updated formula is classified as a trained formula based on the identification that the second set of values correspond to the collected data, and wherein the trained formula is associated with a computer model.

10. The non-transitory computer-related storage medium of claim 9, wherein the one or more processors execute the instructions to:
access the collected data associated with the sample; and
access the set of known parameters of the sample.

11. The non-transitory computer-related storage medium of claim 9, wherein the one or more processors execute the instructions to:
compare the collected data with first set of calculated values; and
generate the updated formula based on the identification that the first set of calculated values do not correspond to the collected data.

12. The non-transitory computer-related storage medium of claim 9, wherein the sample is located in at least one of a wellbore or a cutting taken from the wellbore.

13. The non-transitory computer-related storage medium of claim 9, wherein the one or more processors execute the instructions to:
access data sensed in a wellbore;
perform evaluations according to the updated formula based on the sensed wellbore data; and
identify parameters of a subterranean formation of the wellbore based on the evaluations being performed according to the updated formula.

14. The non-transitory computer-related storage medium of claim 9, wherein the collected data includes data from one or more electromagnetic (EM) measurements, magnetic flux leakage measurements, nuclear magnetic resonance measurements, or acoustic measurements.

15. The non-transitory computer-related storage medium of claim 9, wherein the collected data includes data associated with propagation of EM energy or acoustic energy through the sample.

16. The non-transitory computer-related storage medium of claim 9, wherein the one or more processors execute the instructions to:
access sensor data;
identify that a calculation according to the formula that includes the set of known parameters does not generate results that match the sensor data to a threshold level;
generate a revised formula based on an estimate of a new parameter or a parameter of the set of known parameters; and
identify that a calculation according to the revised formula generates results that match the sensor data to the threshold level.

17. An apparatus comprising:
a memory; and
one or more processors that execute instructions out of the memory to:
identify a formula to associate collected data with a set of known parameters of a sample,
calculate a first set of values according to the formula based on the known parameters of the sample,
identify that the first set of values do not correspond to the collected data,
identify an updated formula to calculate a second set of values, and
identify that the second set of values correspond to the collected data, wherein the updated formula is classified as a trained formula based on the identification that the second set of values correspond to the collected data, and wherein the trained formula is associated with a computer model.

18. The apparatus of claim 17, wherein the one or more processors execute the instructions out of the memory to:
compare the collected data with first set of calculated values, and
generate the updated formula based on the identification that the first set of calculated values do not correspond to the collected data.

19. The apparatus of claim 17, wherein the one or more processors execute the instructions out of the memory to:
access data sensed in a wellbore,
perform evaluations according to the updated formula based on the sensed wellbore data, and
identify parameters of a subterranean formation of the wellbore based on the evaluations being performed according to the updated formula.

20. The apparatus of claim 17, further comprising:
a measurement device that collects one or more of an electromagnetic measurement, a magnetic flux leakage measurement, a nuclear magnetic resonance measurement, or an acoustic measurement.
